(19) United States
(12) Patent Application Publication
(10) Pub. No.: US 2009/0103574 A1
(43) Pub. Date: Apr. 23, 2009

(54) LASER MODULE PACKAGE AND DISPLAY APPARATUS USING THE SAME

(75) Inventor: Heung-Woo Park, Suwon-si (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: SAMSUNG ELECTRO-MECHANICS CO., LTD., Suwon (KR)

(21) Appl. No.: 12/251,999

(22) Filed: Oct. 15, 2008

(30) Foreign Application Priority Data
Oct. 22, 2007 (KR) 10-2007-0106019

(51) Int. Cl. H01S 3/10; H01S 3/04

(52) U.S. Cl. 372/4; 372/34

(57) ABSTRACT

Disclosed are a laser module apparatus and a display apparatus using the same. In accordance with an embodiment of the present invention, a laser module package which generates a green laser beam can include a pumping light source, configured to generate and output a pump beam; a laser medium, configured to receive the pump beam and output an infrared beam; an optical crystal, configured to receive the infrared beam and output a laser beam having a green wavelength band; and a micro heater, configured to be thermally coupled to the pumping light source and control an operation temperature of the pumping light source to be maintained to a predetermined target temperature.

### CROSS-REFERENCE TO RELATED PATENT APPLICATIONS

This application claims the benefit of Korean Patent Application No. 10-2007-0106019, filed on Oct. 22, 2007, in the Korean Intellectual Property Office, the disclosure of which is incorporated herein in its entirety by reference.

### BACKGROUND OF THE INVENTION

1. Field of the Invention

The present invention relates to a laser module package, more specifically to a laser module package and a display apparatus using the same that can control an operation temperature of a laser diode to be regular by mounting a micro heater or a thermoelectric element in the package.

2. Background Art

Today's development of a color display technology has brought about the gradually increased demand of small-sized display apparatuses such as personal digital assistants (PDA) and portable multimedia player (PMP) as well as big-sized display apparatus such as TV and monitors. In order to form a color image, those apparatuses can use either a method separating a beam white color of light emitted from a light source into red, blue and green color beams through a color filter or a method using each separated red, green and blue color light source and performing the simultaneous or successive emission.

At this time, while the red or blue color light source can employ a single laser diode to emit a red or blue color beam of light, it is not easy to manufacture a single laser diode to emit a green color beam of light on commercial business. Accordingly, in the case of the green color beam of light, a pumping beam of light emitted from a pumping light source is allowed to pass through a laser medium to be converted to an infrared beam. Then, the infrared beam is allowed to pass through a predetermined optical crystal to be converted to a green beam of light.

For example, if a pumping beam having the 808 nm wavelength is assumed to be outputted from the pumping light source, the pumping beam can pass through the laser medium to be converted to an infrared beam having the wavelength of 1064 nm. Then, the infrared beam can pass through the optical crystal to be converted to a green beam of light having the wavelength of 532 nm.

In a related green laser module package, each element inside the package such as a pumping light source, a laser medium and an optical crystal is affected by the heat inherently generated according to the change of temperature outside the package or the operation of the green laser module inside the package, to thereby cause the corresponding operation characteristics such as the wavelength and the power of the outputted beam.

For example, in the pumping light source, the increase of 1° C. inside the package causes the wavelength of the pumping beam emitted from the pumping light source to be changed by around 0.3 nm. This may make it impossible for the previously manufactured green laser module to generate the originally desired outputted green laser beam and make the outputted green laser beam unstably vibrated.

Also, while the red or blue laser module has the operation temperature range of about −10˜50° C. for normal operation, the green laser module has the operation temperature range of about 25˜35° C. In other words, the green laser module has the much smaller allowance than the red or blue laser module.

Accordingly, it is required to adequately control the operation temperature of each element included in the green laser module package in order to guarantee more accurate and stable operation of the package.

Also, since the wavelength of the laser beam generated by each laser module having different sensibility is differently changed according to the foregoing change of the operation temperature, the red or blue laser module package can not help generating the laser beam having the wavelength that is differentiated according to the change of the operation temperature as well. Accordingly, the operation temperature of the red or blue laser module package must be adequately controlled in order to keep the operation of the package stable.

### SUMMARY OF THE INVENTION

Accordingly, the present invention provides a laser module package and a display apparatus using the same that can maximize an operation temperature range of a laser module by regularly maintaining the operation temperature of elements included in the laser module by use of a micro heater or a thermoelectric element.

The present invention also provides a laser module package and a display apparatus using the same that can largely reduce power consumption, volume and manufacture cost by using a micro heater or a thermoelectric element working in a heating mode mounted in the package to constantly maintain the operation temperature of a laser module.

The present invention also provides a laser module package and a display apparatus using the same that can be adequately applied to small-sized display apparatuses such as mobile phones, PMP and UMPC as well as large-sized display apparatuses.

An aspect of the present invention features a laser module package which generates a green laser beam, including a pumping light source, configured to generate and output a pump beam; a laser medium, configured to receive the pump beam and output an infrared beam; an optical crystal, configured to receive the infrared beam and output a laser beam having a green wavelength band; and a micro heater, configured to be thermally coupled to the pumping light source and control an operation temperature of the pumping light source to be maintained to a predetermined target temperature.

Here, the pumping light source can generate and output a pump beam having a wavelength of about 808 nm at the target temperature. At this time, at the target temperature, the laser medium can convert the pump beam to an infrared beam having a wavelength of about 1064 nm and the optical crystal can convert the infrared beam to a green laser beam having a wavelength of about 532 nm.

The target temperature can be determined as a highest temperature among operation temperatures of the pumping light source in consideration of a change of external surroundings of the laser module package and an effect depending on an external operation of the laser module package.

The micro heater can be formed in a micro pattern on a surface of the pumping light source. At this time, the micro pattern can be formed in a zigzag shape on the surface of the pumping light source.

The laser module package a temperature sensor, configured to measure the operation temperature of the pumping light source.

The laser module package can further include a heater circuit, configured to control the micro heater to perform a heating if the operation temperature of the pumping light source drops below the target temperature and to stop the heating if the operation temperature of the pumping light source rises above the target temperature

At least one micro heater can be additionally provided to be thermally coupled to both the laser medium and the optical crystal or any one or each of the laser medium and the optical crystal to control an operation temperature of at least one of the laser medium and the optical crystal. At this time, the operation temperature of at least one of the laser medium and the optical crystal can be maintained to a substantially same temperature as the target temperature by the additionally provided micro meter.

Another aspect of the present invention features a laser module package which generates a laser beam, including a pumping light source, configured to generate and output a pump beam; and a micro heater, configured to be thermally coupled to the pumping light source and control an operation temperature of the pumping light source to be maintained to a predetermined target temperature.

Here, the target temperature can be determined as a highest temperature among operation temperatures of the pumping light source in consideration of a change of external surroundings of the laser module package and an effect depending on an external operation of the laser module package.

The micro heater can be formed in a micro pattern on a surface of the pumping light source. At this time, the micro pattern can be formed in a zigzag shape on the surface of the pumping light source.

The laser module package can further include a temperature sensor, configured to measure the operation temperature of the pumping light source.

The laser module package can further include a heater circuit, configured to control the micro heater to perform a heating if the operation temperature of the pumping light source drops below the target temperature and to stop the heating if the operation temperature of the pumping light source rises above the target temperature.

Another aspect of the present invention features a laser module package which generates a green laser beam, including a pumping light source, configured to generate and output a pump beam; a laser medium, configured to receive the pump beam and output an infrared beam; an optical crystal, configured to receive the infrared beam and output a laser beam having a green wavelength band; and a thermoelectric element, configured to be thermally coupled to the pumping light source and to work in a heating mode to control an operation temperature of the pumping light source to be maintained to a predetermined target temperature.

Here, the operation temperatures of the laser medium and the optical crystal can be maintained as a substantially same temperature as the target temperature by allowing the laser medium and the optical crystal to be placed together on the thermoelectric element.

The pumping light source can generates and output a pump beam having a wavelength of about 808 nm at the target temperature. At this time, at the target temperature, the laser medium can convert the pump beam to an infrared beam having a wavelength of about 1064 nm and the optical crystal can convert the infrared beam to a green laser beam having a wavelength of about 532 nm.

The target temperature can be determined as a highest temperature among operation temperatures of the pumping light source in consideration of a change of external surroundings of the laser module package and an effect depending on an external operation of the laser module package

The laser module package can further include a temperature sensor, configured to measure the operation temperature of the pumping light source.

Another aspect of the present invention features a display apparatus including a light source, configured to function as a laser module package; an optical modulator, configured to receive a beam outputted from the light source and to generate and output a modulation beam by modulating the received beam; and a projection apparatus, configured to enlarge and project the modulation beam outputted from the optical modulator. At this time, the laser module package can include a pumping light source, configured to generate and output a pump beam; a laser medium, configured to receive the pump beam and output an infrared beam; an optical crystal, configured to receive the infrared beam and output a laser beam having a green wavelength band; and a micro heater, configured to be thermally coupled to the pumping light source and control an operation temperature of the pumping light source to be maintained to a predetermined target temperature.

Another aspect of the present invention features a display apparatus including a light source, configured to function as a laser module package; an optical modulator, configured to receive a beam outputted from the light source and to generate and output a modulation beam by modulating the received beam; and a projection apparatus, configured to enlarge and project the modulation beam outputted from the optical modulator. At this time, the laser module package can include a pumping light source, configured to generate and output a pump beam; and a micro heater, configured to be thermally coupled to the pumping light source and control an operation temperature of the pumping light source to be maintained to a predetermined target temperature.

Another aspect of the present invention features a display apparatus including a light source, configured to function as a laser module package; an optical modulator, configured to receive a beam outputted from the light source and to generate and output a modulation beam by modulating the received beam; and a projection apparatus, configured to enlarge and project the modulation beam outputted from the optical modulator. At this time, the laser module package can include a pumping light source, configured to generate and output a pump beam; a laser medium, configured to receive the pump beam and output an infrared beam; an optical crystal, configured to receive he infrared beam and output a laser beam having a green wavelength band; and a thermoelectric element, configured to be thermally coupled to the pumping light source and to function in a heating mode to control an operation temperature of the pumping light source to be maintained to a predetermined target temperature.

### BRIEF DESCRIPTION OF THE DRAWINGS

These and other features, aspects and advantages of the present invention will become better understood with regard to the following description, appended claims and accompanying drawings where:

FIG. 1 shows a brief structure of a green laser module package having a horizontal configuration applicable to the present invention;

FIG. 2A shows a brief structure of a green laser module package having a vertical configuration applicable to the present invention;

FIG. 2B shows how a part of the green laser module package of FIG. 2A is viewed in a direction;

FIG. 3 is the structure showing a typical laser diode applicable to the present invention;

FIG. 4 shows a green laser module package in accordance with a first embodiment of the present invention;

FIG. 5 shows a green laser module package in accordance with a second embodiment of the present invention;

FIG. 6A shows an example of a micro heater formed in a micro-pattern on one surface of a laser diode;

FIG. 6B shows another example of a micro heater formed in a micro-pattern on one surface of a laser diode;

FIG. 6C shows a heater circuit for the operation micro heater mounted inside a laser diode;

FIG. 6D is graphs showing the difference of times that it takes to reach to a target temperature in the two cases of using a micro heater mounted in an optical modulator and using no micro heater;

FIG. 7 shows a green laser module package in accordance with a third embodiment of the present invention;

FIG. 8 shows a green laser module package in accordance with a fourth embodiment of the present invention;

FIG. 9 shows an example of a projective display apparatus to which a laser module package of the present invention is applied.

### DESCRIPTION OF THE EMBODIMENTS

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the spirit and scope of the present invention. Throughout the drawings, similar elements are given similar reference numerals. Throughout the description of the present invention, when describing a certain technology is determined to evade the point of the present invention, the pertinent detailed description will be omitted.

Terms such as “first” and “second” can be used in describing various elements, but the above elements shall not be restricted to the above terms. The above terms are used only to distinguish one element from the other. For instance, the first element can be named the second element, and vice versa, without departing the scope of claims of the present invention. The term “and/or” shall include the combination of a plurality of listed items or any of the plurality of listed items.

The terms used in the description are intended to describe certain embodiments only, and shall by no means restrict the present invention. Unless clearly used otherwise, expressions in the singular number include a plural meaning. In the present description, an expression such as “comprising” or “consisting of” is intended to designate a characteristic, a number, a step, an operation, an element, a part or combinations thereof, and shall not be construed to preclude any presence or possibility of one or more other characteristics, numbers, steps, operations, elements, parts or combinations thereof.

Unless otherwise defined, all terms, including technical terms and scientific terms, used herein have the same meaning as how they are generally understood by those of ordinary skill in the art to which the invention pertains. Any term that is defined in a general dictionary shall be construed to have the same meaning in the context of the relevant art, and, unless otherwise defined explicitly, shall not be interpreted to have an idealistic or excessively formalistic meaning.

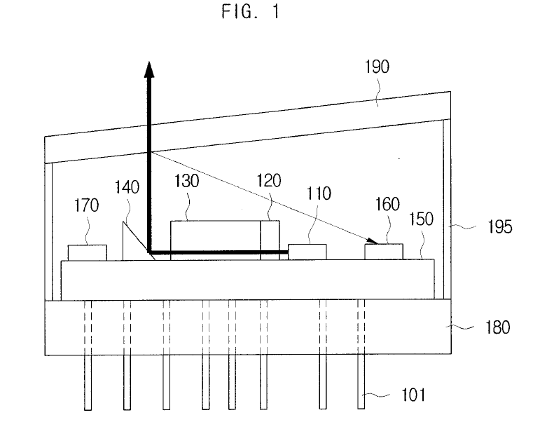

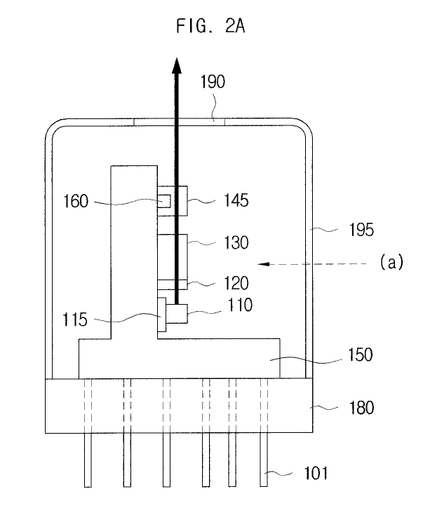

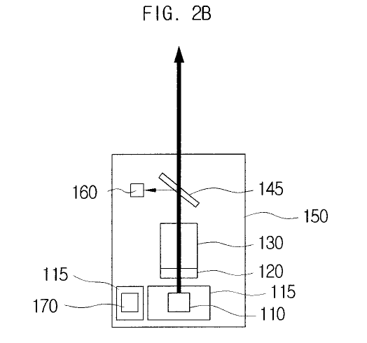

Before some embodiments of the present invention is described in detail with reference to the accompanying drawings, a green laser module package will be described with reference to FIG. 1 through FIG. 2B as an example of a laser module package applicable to the present invention.

FIG. 1 shows a brief structure of a green laser module package having a horizontal configuration applicable to the present invention, and FIG. 2A shows a brief structure of a green laser module package having a vertical configuration applicable to the present invention. FIG. 2B shows how a part of the green laser module package of FIG. 2A is viewed in a direction.

As shown in FIG. 1, the green laser module package can include a pumping light source 110, a laser medium 120, an optical crystal 130, a reflective mirror 140, an accommodating part 150, a light detector 160, a temperature sensor 170, a stem 180, a driving pin 101, a penetrable window 190 and a sealing cap 195. At this time, the green laser module package of FIG. 1 can be designed to have a horizontal configuration in which an optical axis of a green laser beam converted and outputted from the optical crystal 130 is arranged in parallel with a base surface of the package.

Here, the accommodating part 150, formed to accommodate each element of the green laser module package, the stem 180, placed in the base surface of the package and to support the overall package, a plurality of driving pins 101, mounted to supply a driving voltage for each element (e.g. the pumping light source 100, the accommodating part 150, the light detecting unit 160 and the temperature sensor 170), the sealing cap 195, mounted to package and protect the green laser module and the penetrable window 190, mounted to output a green laser beam generated through the green laser module to the outside of the package are well known. Accordingly, the pertinent detailed description will be omitted.

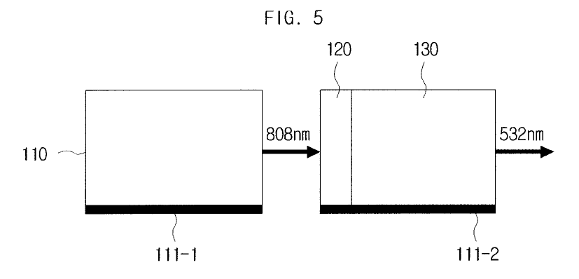

The pumping light source 110 can generate and output a pump beam. For example, the pumping light source 110 can generate and output a pump beam having the wavelength of nm. Herein, the pumping light source 110 can employ a semiconductor laser diode (refer to FIG. 5A) formed to include multimedia thin films of InGaAa or GaN system semiconductor and so on.

The laser medium 120 can receive the pump beam outputted from the pumping light source 100 and convert the received pump beam to an infrared beam. Herein, any material capable of performing laser oscillation including Neodymium:Yttrium Vanadate (Nd:YVO4) and Neodymium:Yttrium Aluminum Garnet (Nd:YAG) can be used without any restriction. The optical crystal 130 can receive the infrared beam converted and outputted through the laser medium 120 and convert the received infrared beam to a laser beam having a green wavelength band. Herein, the optical crystal 130 can employ an NLO crystal such as a KTP crystal (Potassium-titanyl-phosphate crystal), for example.

For example, if the pumping light source 110 outputs a pump beam having the wavelength of about 808 nm, the laser medium can convert the pump beam having the wavelength of about 808 nm to an infrared beam having the wavelength of about 1064 nm and the optical crystal 130 can convert the infrared beam having the wavelength of about 1064 nm to a green laser beam having the wavelength of about 532 nm.

At this time, as shown in FIG. 1, the laser medium 120 and the optical crystal 130 can be mounted as one body by allowing a light-outputting surface of the laser medium 120 to be in contact with a light-inputting surface of optical crystal 130. Also, the laser medium 120 and the optical crystal 130 can be arranged to have the same optical axis as the pumping light source 110 in order to receive the pump light outputted from the pumping light source 110 without loss.

The reflective mirror 140 can receive the green laser beam outputted from the optical crystal 130 and reflect the inputted green laser beam so as to allow a light path of the inputted green laser beam to have a vertical direction with respect to the optical axis of the pumping light source 110. This may be to allow the green laser beam outputted from the optical crystal 130 to undergo the penetrable window 190 before being outputted to the outside of the green laser module package because the green laser module package of FIG. 1 has a horizontal configuration.

The temperature sensor 170 can measure the operation temperature of at least one of each element (e.g. the pumping light source 110, the laser medium 120 and the optical crystal 130), the operation temperature of which are necessary to be controlled, according to the design. Herein, the temperature sensor 170 can be arranged at an optimized point in which the thermistor 170 is possible to measure the operation temperature of the pertinent element to be measured by being connected to the pertinent element through a circuit, according to the design without any restriction.

The light detector 160 can constantly maintain the light output magnitude of the green laser beam generated and outputted through the green laser module package of the present invention and/or monitor the light output magnitude of the green laser beam to have desired light output magnitude. For example, the light detector 160, as shown in FIG. 1, can monitor the light output magnitude by detecting some of the green laser beams emitted toward the penetrable window 190, reflected by the penetrable window 190.

Herein, the penetrable window 190 can be arranged to have a slope of a predetermined angle with respect to an orthogonal surface of the optical axis of the green laser beam to be outputted to the outside of the package, and the light detector 160 can be arranged at a suitable point so as to receive the green laser beam reflected by the penetrable window 190 according to the angle of the penetrable window 190. Inversely, the configuration angle of the penetrable window 190 can be adjusted depending on the configuration position of the light detector 160.

FIG. 2A and FIG. 2B show a green laser module package having a vertical configuration. It shall be obvious that various configurations and principles of the green laser module package having the vertical configuration described with reference to FIG. 1 can be applied to the green laser module package having the vertical configuration described with reference to FIG. 2A and FIG. 2B, except for the case of being unable to be applied due to its structural difference.

The below description focuses on the difference of configuration or design between the green laser module package having the horizontal configuration and the green laser module package having the vertical configuration.

As shown in FIG. 2A and FIG. 2B, the green laser module package can include the pumping light source 110, a sub-mount 115, the laser medium 120, the optical crystal 130, a beam splitter 145, the accommodating part 150, the light detector 160, the temperature sensor 170, the stem 180, the plurality of driving pins 101, the penetrable window 190 and the sealing cap 195.

Here, sub-mount 115 can be pre-mounted as necessary to be suitable for the standard of a desired element in consideration of the convenience of carrying and mounting. For example, the sub-mount 115 can be formed by using a material having good heat transmission and enough flat level such as AIN and can be electrically connected to the pumping light source 110 by a die bonding and/or a wire bonding.

Here, the green laser module package shown in FIG. 2A and FIG. 2B can be designed to have a vertical configuration in which an optical axis of a green laser beam converted and outputted from the optical crystal 130 is arranged orthogonally to a base surface of the package. In the vertical configuration, since the original direction of the optical axis of the green laser beam outputted from the optical crystal 130 is toward the penetrable window 190, it may be unnecessary to separately mount the reflective mirror 140 unlike the foregoing horizontal configuration.

The beam splitter 145 can receive the green laser beams generated and outputted from the optical crystal 130 and divide the received green laser beams to allow some of the green laser beams to move toward the penetrable window 910 and the others to move toward the light detector 160. For example, using the beam splitter 145 makes it possible to help the light detector 160 to monitor the light output magnitude of the generated green laser beam by allowing 98% or more of the received green laser beams to be outputted to be the outside of the package through the penetrable window 190 and 2% or less to be reflected in a direction in which the light detector 160 is placed.

Although the description with reference to FIG. 2A and FIG. 2B focuses on the case that the light detector 160 monitors the light output magnitude by dividing the green laser beams by use of the beam splitter 145, it is obviously possible that the penetrable window 190 is arranged to have a slope of a predetermined angle with respect to an orthogonal surface of the optical axis of the green laser beam to be outputted to the outside of the package, and the light detector 160 is arranged at a suitable point so as to receive the green laser beam reflected by the penetrable window 190, which is arranged according to the angle of the penetrable window 190, as shown in FIG. 1.

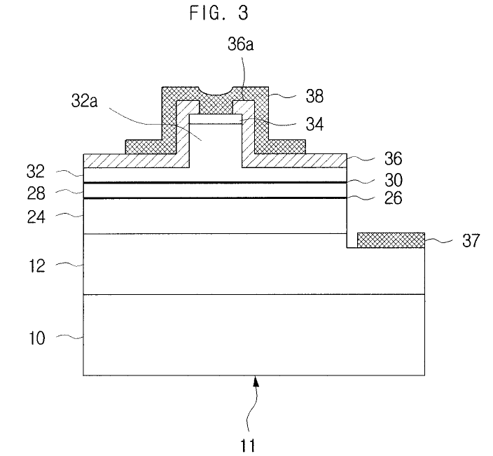

FIG. 3 is the structure showing a typical laser diode applicable to the present invention. In particular, FIG. 3 shows a semiconductor laser diode formed to include multilayer thin films of compound semiconductors (e.g. GaN system compound semiconductor).

As shown in FIG. 3, the laser diode can include a sapphire substrate 10, an n-GaN lower contact layer 12, an n-GaN/AlGaN lower class layer 24, an n-GaN lower waveguide layer 26, an InGaN active layer 28, a p-GaN upper waveguide layer 30, a p-GaN/AlGaN upper class layer 32 and a p-GaN upper contact layer 34. A passivation layer 36, a p-type upper electrode 38 and an n-type lower electrode 37 can be stacked in the upper class layer 32, the upper contact layer 34 and the lower contact layer 12, respectively.

At this time, the lower and upper class layers 24 and 32 can be designed to have the smaller refractive index than the lower and upper contact layers 26 and 30, and the lower and upper contact layers 26 and 30 can be designed to have the smaller refractive index than the active layer 28. Also, the laser diode can be designed to have the ridge waveguide structure capable of reducing a threshold current value for the laser oscillation by allowing a ridge 32a having a predetermined width to be formed at a center area of an upper part of the upper class layer 32.

The ridge waveguide structure formed at the upper class layer 32 can adjust the amount of a current transferred to the active layer 28 to control the width of a resonance area for the laser oscillation of the active layer 28. At this time, restricting the width of the resonance area makes it possible to allow a transverse mode to become stable and a corresponding operation current to drop.

Such a semiconductor laser diode can maintain the oscillation of a laser beam at a limited space, to thereby make it easy to be miniaturized and integrated. Also, the semiconductor laser diode may need a small threshold current value for the laser oscillation, which results in various applications to industrial fields.

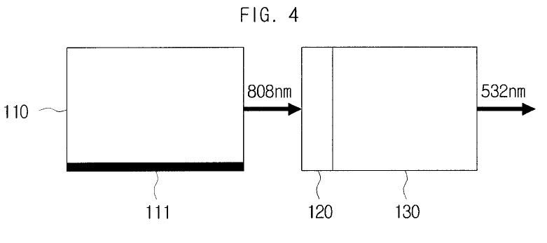

FIG. 4 shows a green laser module package in accordance with a first embodiment of the present invention, and FIG. 5 shows a green laser module package in accordance with a second embodiment of the present invention.

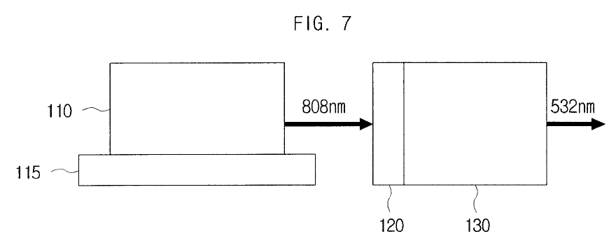

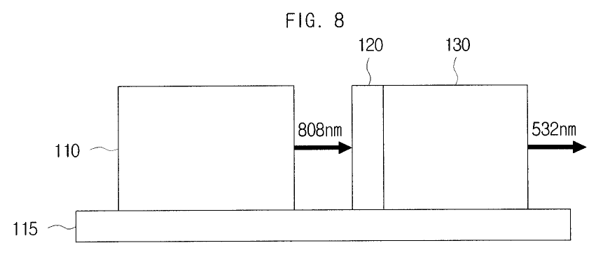

At this time, the green laser module package can have the same configuration as described in FIG. 1 through FIG. 2B. FIG. 4 and FIG. 5 show some elements related to the present invention and do not show the others of the whole elements of the green laser module package. The same is also applied to FIG. 7 and FIG. 8 to be described later. Accordingly, the below description focuses on some elements to be added to the green laser module package of the present invention.

As described in FIG. 4, the green laser module package in accordance with an embodiment of the present invention can include the pumping light source 110, a micro heater 111, coupled to the pumping source 110, and the optical crystal 130.

The micro heater 111 can be placed inside the green laser module package and be thermally coupled to the pumping light source 110 in order to control the operation temperature of the pumping light source 110 to be maintained as a predetermined target temperature.

Here, the meaning of “being thermally coupled to an element” to control the operation temperature of the element include a case of allowing the micro heater 111 to be directly coupled or attached to the element to control the operation temperature of the element and a case of allowing the micro heater 111 to be thermally coupled to the element through a predetermined heat-conductive material to control the operation temperature of the element. As one of good examples, the micro heater 111 of the present invention can be mounted together (i.e. formed as one body) with the pumping light source 110 in order to reduce the whole size and volume of the laser module package to be manufactured and to maximize the heating efficiency.

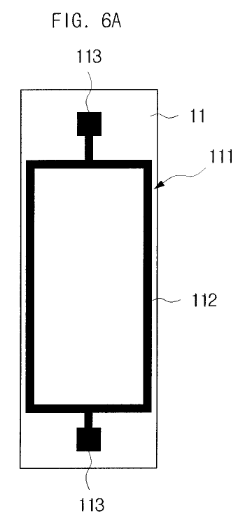

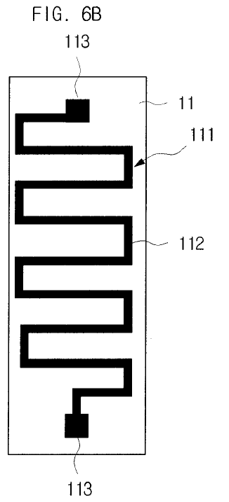

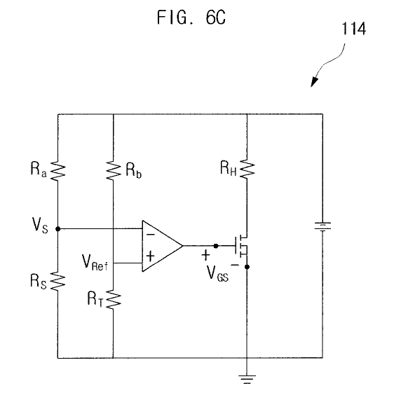

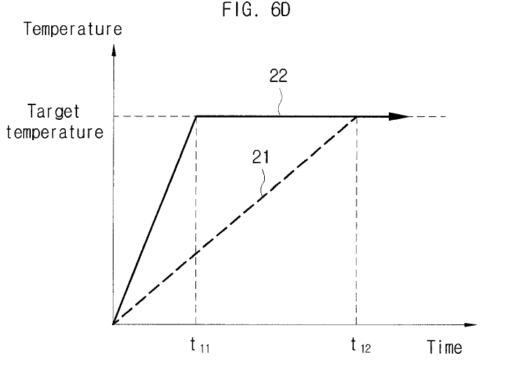

FIG. 6A shows an example of a micro heater formed in a micro-pattern on one surface of a laser diode, and FIG. 6B shows another example of a micro heater formed in a micro-pattern on one surface of a laser diode. As described in FIG. 6A and FIG. 6B, the micro heater 111 can be formed in a micro pattern on a surface of the pumping light source 110. For example, FIG. 6A and FIG. 6B show that the laser diode described with reference to FIG. 3 is employed for the pumping light source 110 and the micro heater is formed on the base surface 11 of FIG. 3).

As such, an electrode 113 can be formed on the surface 11 of the laser diode, and the micro heater 111 can be mounted inside the laser diode as a wire formed in a certain pattern connecting between opposite electrodes 113. As shown in FIG. 6A, the wire 112 of the micro heater 111 can be formed in a rectangular pattern adjacently to an edge part of the surface 11 of the laser diode and along the edge part. As shown in FIG. 6B, the wire 112 of the micro heater 111 can be formed in a zigzag pattern on the surface 11 of the laser diode.

In case that the micro heater 111 is formed in the zigzag pattern as shown in FIG. 6B, the micro heater 111 can evenly transfer the heat to the whole parts of the laser diode. Here, the micro pattern of the micro heater 111 can be formed by using conductive thin film made of a conductive material such as platinum.

A heater circuit 114 for controlling the heating operation of the micro heater 111 can have the same configuration as described FIG. 6C, for example. A sensing resistance R_{S} and a heater resistance R_{H} can be included in the structure of the micro heater 111 formed in the pattern on the surface 11 of the laser diode. Here, a reference resistance R_{T} can have a value allowing the heater circuit 632 to be turned on or off to meet the target temperature by being linked with sensing resistance R_{S}.

Accordingly, if the operation temperature of the laser diode is lower than a predetermined target temperature, the smaller sensing resistance R_{S} may cause the voltage V_{S} inputted into a (−) port of a computing amplifier to be decreased. This may result in allowing a gate-source voltage V_{GS} of a Mos transistor to become larger than its threshold value, which causes a current to flow through the heater resistance R_{H} connected to a drain port of the Mos transistor. This may makes the heater circuit 114 turned on.

Inversely, if operation temperature of the laser diode is higher than the target temperature, the higher sensing resistance R_{S} may cause the voltage V_{S} inputted into a (−) port of a computing amplifier to be increased. This may result in allowing the gate-source voltage V_{GS} of the Mos transistor to become smaller than its threshold value, which causes no current to flow through the heater resistance R_{H} connected to a drain port of the Mos transistor. This may makes the heater circuit 114 turned off.

As such, the heater circuit 114 can be designed to allow the micro heater 111 to perform the heating if the operation temperature of the laser diode drops below the target temperature and to stop heating if the operation temperature of the laser diode rises above the target temperature.

At this time, the heater circuit 114 can control the heating ratio per hour of the laser diode by the micro heater 111 by adjusting the amount of a current supplied to the micro-pattern of the micro heater 111. FIG. 6D shows a first straight line 21 and a second straight line 22 on the time-temperature coordinate plane. The first straight line 21 represents the change ratio of the operation temperature of the laser diode according to the change of the environmental surrounding temperature in the case of using no heating of the micro heater 631. The second straight line 22 represents the change ratio in the case of using the heating of the micro heater 111.

Through FIG. 6D, it is recognized that the case of using no micro heater 111 may need more time that it takes to reach to the target temperature than the case of using the micro heater 111. This is because it may take a certain time for the operation temperature of the optical modulator. Accordingly, in the case of using no heating of the micro heater 111, the laser diode may not perform the expected accurate optical modulation during the time t₁₂ corresponding to the gradient of the first straight line 21.

However, in the case of using the heating of the micro heater 111, the laser diode can perform the expected accurate optical modulation within a shorter time t₁₁. At this time, the gradient of the second straight line 22 (i.e. the heating ratio per hour) can be adjusted to have a larger value by increasing the amount of the current supplied from the heater circuit 114 to the micro heater 111.

Here, the target temperature may be determined as a highest temperature in an operation temperature range in consideration of the change of external surrounding of the laser module package and the effect according to an internal operation of the laser module package. For example, if it is assumed that the laser module package is applied to the inside of a display system of a mobile terminal, 20° C. may be increased in the laser module package based on the external surrounding temperature.

For example, if the highest external surrounding temperature is assumed to be 60° C. according to the operation condition, the temperature of the laser module package may rise until about 80° C. Accordingly, the target temperature can be determined as the highest temperature of 80° C. in the same assumption.

In this case, in order to maintain the operation temperature of the lager diode as 80° C., the heater circuit 114 can be designated to supply a current to the micro pattern of the micro heater 111, to thereby allow the micro heater 111 to perform the heating operation if the temperature of the laser diode drops below 80° C.

As one of good examples, the pumping light source 110 of the present invention can employ the laser diode manufactured to generate and output a pump beam of 808 nm based on the time when the laser diode has the operation temperature of 80° C. Designing and manufacturing the laser module package of the present invention as described above makes it possible to allow the laser diode to generate and output the pump beam of 808 nm regardless of the change of temperature with the accuracy and reliability.

Here, the laser medium 120 and the optical crystal 130 may be required to be designed to convert the pump beams having 808 nm inputted at the target temperature to the green laser beams having the wavelengths of 1064 nm and 532 nm, respectively.

Accordingly, the laser medium 120 and the optical crystal 130 may be required to be designed to have each determination direction capable of allowing corresponding operations to be optimized at the target temperature. This can be performed by adjusting a cutting angle when the laser medium 120 and the optical crystal 130 are manufactured.

Below is the reason that the target temperature is determined as the highest temperature of the temperature range of the laser diode. If the target temperature is determined as the normal temperature, the operation temperature of the laser diode is likely to be changed beyond the target temperature. This may make it impossible to guarantee the accuracy and reliability of the operation.

Of course, determining the target temperature as the highest temperature may cause the heating operation of the micro heater 111 to be more frequently performed as compared with determining the target temperature as the lower temperature than the highest temperature, which results in more power consumption. However, the determination of the target temperature as the highest temperature may have much less power consumption than the case of determining the target temperature as the lower temperature and allowing a thermoelectric element to perform the cooling to prevent the operation temperature of the laser diode from rising above the target temperature.

This may be because using the thermoelectric element to cool the pertinent element needs much more power consumption than using the micro heater 111 to heat the element. As a result, the present invention can guarantee the accuracy and reliability of the operation of the laser module package in spite of having the relative smaller power consumption.

Although the above description focuses on the case that the heating operation is controlled to be performed by the micro heater 111 by allowing the operation temperature of the laser diode to be independently sensed by the sensing resistance Rs (i.e. the heater circuit 114 including the temperature sensing function), the present invention can alternatively use the case of separately providing the temperature sensor 170 and controlling the heating operation of the micro heater 111 according to the temperature sensed by the temperature sensor 170. Herein, the temperature sensor 170 can employ a thin-film RTD temperature sensor and a thermistor.

Also, even though the description with reference to FIG. 4 concentrates on the case that the pumping light source 110 is controlled to be maintained as the predetermined target temperature by the micro heater 111, the micro heater 111 can be naturally control the operation temperature of at least one of the laser medium 120 and the optical crystal 130.

In other words, the description with reference to FIG. 4 focuses on the pumping light source 110, which is more sensible to the operation property changed according to the change of temperature, and shows that the operation temperature of the pumping light source 110 is controlled by allowing the micro heater 111 to coupled to the micro heater 111. However, the laser medium 120 and the optical crystal 130 can also have their operation properties changed according to the change of temperature.

Accordingly, the green laser module package in accordance with a second embodiment of the present invention can additionally equip a micro heater 111-2 for controlling the operation temperatures of the laser medium 120 and the optical crystal 130 in order to allow the laser module package to perform the more accurate operation. At this time, the operation temperatures of the laser medium 120 and the optical crystal 130 can be also controlled to be maintained as the target temperature of a highest temperature (e.g. 80° C.) by the additionally equipped micro heater 111-2 similarly to the pumping light source 110.

In this case, the laser medium 120 and the optical crystal 130 can be designed and manufactured to conversion-output an infrared beam of the wavelength 1064 nm and a green laser beam of the wavelength 532 nm, respectively, at the target temperature.

FIG. 7 shows a green laser module package in accordance with a third embodiment of the present invention, and FIG. 8 shows a green laser module package in accordance with a fourth embodiment of the present invention.

As shown in FIG. 7, the green laser module package in accordance with a third embodiment of the present invention can include the pumping light source 110, a thermoelectric element 115, the laser medium 120 and the optical crystal 130.

Here, the thermoelectric element 115 can be placed inside the green laser module package and control the operation temperature of the pumping light source 110 to be maintained as a predetermined target temperature by being thermally coupled to the pumping light source 110. In other words, the thermoelectric element 115 of FIG. 7 can function to replace the micro heater 111 described with reference to FIG. 4 and FIG. 5.

As a result, the thermoelectric element 115 can maintain the operation temperature of the pumping light source 110 as the target temperature determined as the highest temperature by keeping the thermoelectric element 115 in a heating mode instead of a cooling mode. For example, the thermoelectric element 115 can heat the pumping light source 110 to regularly maintain the operation temperature of the pumping light source 110 as 80° C., to thereby make it possible for the pumping light source 110 to generate and output a pump beam of the wavelength 808 nm at the target temperature.

The thermoelectric element 115 refers to a semiconductor that uses the Peltier effect that two different type metals are adhered to each other and if a current flows the two adhered materials, one side (e.g. a lower surface of the thermoelectric element 115 of FIG. 7) has an endothermic reaction and the other side (e.g. an upper surface of the thermoelectric element 115 of FIG. 7) has an exothermic reaction. At this time, the thermoelectric element 114 can not only control its same surface to have the endothermic reaction or the exothermic reaction according to the direction of the flowing current but also control heat absorption (i.e. a cooling rate) and heat emission (i.e. a heating rate) by adjusting the amount of current.

Accordingly, adjusting a direction and an amount of a current flowing through the thermoelectric element 115 makes it possible to control the pumping light source 110 to be heated to a predetermined temperature by allowing one surface of the pumping light source 110 to have the exothermic reaction. In the present invention, since the thermoelectric element 115 keeps in the heating mode, the thermoelectric element 115 may have much less smaller power consumption than the case of being in the cooling mode.

At this time, since the thermoelectric element 115 is not formed as one body with the pumping light source 110 dissimilarly to the micro heater 111, the laser module packages in FIG. 7 and FIG. 8 may have a little more increased size and volume than in FIG. 4 and FIG. 5. Also, the laser module packages in FIG. 7 and FIG. 8 may have a little less heat transfer efficiency (i.e. heating efficiency).

However, the same principle described with reference to FIG. 4 and FIG. 5 can be applied to the description with reference to FIG. 7. Also, in accordance with a fourth embodiment of the present invention, the green laser module package can allow the operation temperatures of the laser medium 120 and the optical crystal 130 to be controlled together with the pumping light source 110.

At this time, the description with reference to FIG. 8 assumes that the pumping light source 110, the laser medium 120 and the optical crystal 130 are placed together on one thermoelectric element 115, separately equipped elements can control the operation temperatures of each or combinations of the pumping light source 110, the laser medium 120 and the optical crystal 130.

Even though the above description is mainly related to the green laser module package described with reference to FIG. 3 thorough FIG. 7, it shall be easily understood by any person of ordinary skill in the art that the same principle of the present invention (i.e. to control a temperature of a pertinent element inside the laser module package to be maintained to a highest temperature by using a micro heater or a thermoelectric element) can be applied to other laser module package.

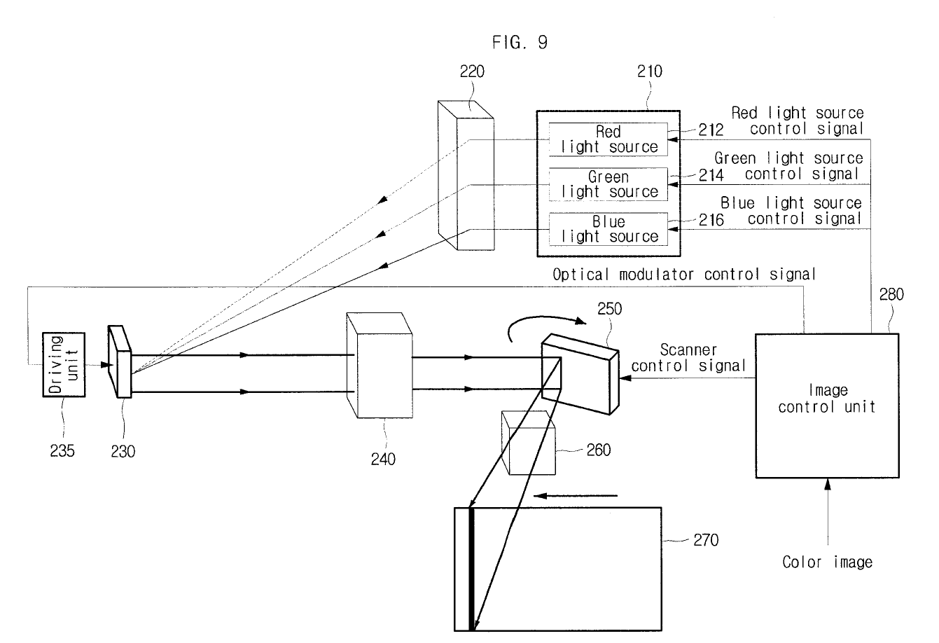

Also, the laser module package described above with reference to FIG. 3 through FIG. 7 can be used as a light source of a projection display apparatus. For example, the projection apparatus can be manufactured as shown in FIG. 9.

In particular, the projection display apparatus can include a light source 210, functioning as a laser module package, an optical modulator, receiving each color laser beam generated and outputted by the light source 210 and outputting a modulation beam according to image information (i.e. each light intensity information or gray scale information related to each pixel) transferred from an image control unit 280, and a projection apparatus 260, enlarging and projecting the modulation beam outputted from the optical modulator 230 on a screen 270.

Here the optical modulator 230 can employ a projection, reflection or diffraction optical modulator without any restriction. Since the projection, reflection or diffraction optical modulator pertain to one of well-known technologies, the detailed pertinent description will be omitted.

At this time, in case that the optical modulator 230 is a one-dimensional optical modulator (which performs the optical modulation of the one-dimensional image according to vertical or horizontal scanning lines of a 1 frame image), the optical modulator 230 can further include an optical scanning device 250, receiving a modulation beam and scanning the received modulation beam on the screen 270 (e.g. a Galvanometer scanner and a polygon mirror scanner, for example).

In addition, the projection display apparatus of FIG. 9 further includes a light optical system 220 and a relay optical system 240. Since the light optical system 220 and the relay optical system 240 are merely well-known elements of a display apparatus, the detailed pertinent description will be omitted.

Hitherto, although some embodiments of the present invention have been shown and described for the above-described objects, it will be appreciated by any person of ordinary skill in the art that a large number of modifications, permutations and additions are possible within the principles and spirit of the invention, the scope of which shall be defined by the appended claims and their equivalents.

1. A laser module package which generates a green laser beam, comprises:
a pumping light source, configured to generate and output a pump beam;
a laser medium, configured to receive the pump beam and output an infrared beam;
an optical crystal, configured to receive the infrared beam and output a laser beam having a green wavelength band; and
a micro heater, configured to be thermally coupled to the pumping light source and control an operation temperature of the pumping light source to be maintained to a predetermined target temperature.

2. The laser module package of claim 1, wherein the pumping light source generates and outputs a pump beam having a wavelength of about 808 nm at the target temperature.

3. The laser module package of claim 2, wherein, at the target temperature, the laser medium converts the pump beam to an infrared beam having a wavelength of about 1064 nm and the optical crystal converts the infrared beam to a green laser beam having a wavelength of about 532 nm.

4. The laser module package of claim 1, wherein the target temperature is determined as a highest temperature among operation temperatures of the pumping light source in consideration of a change of external surroundings of the laser module package and an effect depending on an external operation of the laser module package.

5. The laser module package of claim 1, wherein the micro heater is formed in a micro pattern on a surface of the pumping light source.

6. The laser module package of claim 5, wherein the micro pattern is formed in a zigzag shape on the surface of the pumping light source.

7. The laser module package of claim 1, further comprising: a temperature sensor, configured to measure the operation temperature of the pumping light source.

8. The laser module package of claim 1, further comprising: a heater circuit, configured to control the micro heater to perform a heating if the operation temperature of the pumping light source drops below the target temperature and to stop the heating if the operation temperature of the pumping light source rises above the target temperature.

9. The laser module package of claim 1, wherein at least one micro heater is additionally provided to be thermally coupled to both the laser medium and the optical crystal or any one or each of the laser medium and the optical crystal to control an operation temperature of at least one of the laser medium and the optical crystal.

10. The laser module package of claim 9, wherein the operation temperature of at least one of the laser medium and the optical crystal is maintained to a substantially same temperature as the target temperature by the additionally provided micro meter.

11. A laser module package which generates a laser beam, comprises:
a pumping light source, configured to generate and output a pump beam; and
a micro heater, configured to be thermally coupled to the pumping light source and control an operation temperature of the pumping light source to be maintained to a predetermined target temperature.

12. The laser module package of claim 11, wherein the target temperature is determined as a highest temperature among operation temperatures of the pumping light source in consideration of a change of external surroundings of the laser module package and an effect depending on an external operation of the laser module package.

13. The laser module package of claim 11, wherein the micro heater is formed in a micro pattern on a surface of the pumping light source.

14. The laser module package of claim 13, wherein the micro pattern is formed in a zigzag shape on the surface of the pumping light source.

15. The laser module package of claim 11, further comprising: a temperature sensor, configured to measure the operation temperature of the pumping light source.

16. The laser module package of claim 11, further comprising: a heater circuit, configured to control the micro heater to perform a heating if the operation temperature of the pumping light source drops below the target temperature and to stop the heating if the operation temperature of the pumping light source rises above the target temperature.

17. A laser module package which generates a green laser beam, comprises:
a pumping light source, configured to generate and output a pump beam;
a laser medium, configured to receive the pump beam and output an infrared beam;
an optical crystal, configured to receive the infrared beam and output a laser beam having a green wavelength band; and
a thermoelectric element, configured to be thermally coupled to the pumping light source and to work in a heating mode to control an operation temperature of the pumping light source to be maintained to a predetermined target temperature.

18. The laser module package of claim 17, wherein the operation temperatures of the laser medium and the optical crystal are maintained as a substantially same temperature as the target temperature by allowing the laser medium and the optical crystal to be placed together on the thermoelectric element.

19. The laser module package of claim 17, wherein the pumping light source generates and outputs a pump beam having a wavelength of about 808 nm at the target temperature.

20. The laser module package of claim 19, wherein, at the target temperature, the laser medium converts the pump beam to an infrared beam having a wavelength of about 1064 nm and the optical crystal converts the infrared beam to a green laser beam having a wavelength of about 532 nm.

21. The laser module package of claim 17, wherein the target temperature is determined as a highest temperature among operation temperatures of the pumping light source in consideration of a change of external surroundings of the laser module package and an effect depending on an external operation of the laser module package.

22. The laser module package of claim 17, further comprising: a temperature sensor, configured to measure the operation temperature of the pumping light source.

23. A display apparatus comprising:
a light source, configured to function as a laser module package;
an optical modulator, configured to receive a beam outputted from the light source and to generate and output a modulation beam by modulating the received beam; and
a projection apparatus, configured to enlarge and project the modulation beam outputted from the optical modulator,
whereas the laser module package comprises a pumping light source, configured to generate and output a pump beam;
a laser medium, configured to receive the pump beam and output an infrared beam;
an optical crystal, configured to receive the infrared beam and output a laser beam having a green wavelength band; and
a micro heater, configured to be thermally coupled to the pumping light source and control an operation temperature of the pumping light source to be maintained to a predetermined target temperature.

24. A display apparatus comprising:
a light source, configured to function as a laser module package;
an optical modulator, configured to receive a beam outputted from the light source and to generate and output a modulation beam by modulating the received beam; and
a projection apparatus, configured to enlarge and project the modulation beam outputted from the optical modulator,
whereas the laser module package comprises a pumping light source, configured to generate and output a pump beam; and
a micro heater, configured to be thermally coupled to the pumping light source and control an operation temperature of the pumping light source to be maintained to a predetermined target temperature.

25. A display apparatus comprising:
a light source, configured to function as a laser module package;
an optical modulator, configured to receive a beam outputted from the light source and to generate and output a modulation beam by modulating the received beam; and
a projection apparatus, configured to enlarge and project the modulation beam outputted from the optical modulator,
whereas the laser module package comprises a pumping light source, configured to generate and output a pump beam;
a laser medium, configured to receive the pump beam and output an infrared beam;
an optical crystal, configured to receive the infrared beam and output a laser beam having a green wavelength band; and
a thermoelectric element, configured to be thermally coupled to the pumping light source and to function in a heating mode to control an operation temperature of the pumping light source to be maintained to a predetermined target temperature.
